(19) United States
(12) Patent Application Publication
(10) Pub. No.: US 2021/0049889 A1
(43) Pub. Date: Feb. 18, 2021

(54) INFORMATION PROCESSING DEVICE AND INFORMATION PROCESSING SYSTEM

(71) Applicant: SYSTEM 21 Inc., Tokyo (JP)

(72) Inventors: Yoshiko FUKUDA, Tokyo (JP); Takafumi KUBO, Tokyo (JP); Yoshitaka TANAHASHI, Tokyo (JP); Masashi MIHARA, Tokyo (JP); Masahide TOMITA, Tokyo (JP)

(73) Assignee: SYSTEM 21 Inc., Tokyo (JP)

(21) Appl. No.: 16/978,642

(22) PCT Filed: Mar. 8, 2019
(86) PCT No.: PCT/JP2019/009454

§ 371 Date: Sep. 4, 2020

(30) Foreign Application Priority Data
Mar. 9, 2018 (JP) 2018-043035

(51) Int. Cl. G08B 21/04

(52) U.S. Cl. CPC G08B 21/0423; G08B 21/0446

(57) ABSTRACT

The present invention addresses the problem of enabling another person to easily acquire the current status of a person who has difficulty transmitting information indicating the current status of said person's body to the other person. A detection unit 12 detects a physical amount based on pressure from at least a portion of a person's leg. A management unit 11 transmits prescribed information from a transmission unit 112 when the physical amount detected by the detection unit 12 satisfies a prescribed standard. The transmission unit 112 can also transmit, as prescribed information, information that is used to specify a position at which a transmission device 1 is present. Through this, the abovementioned problem is solved.

### TECHNICAL FIELD

The present invention relates to an information processing device and an information processing system.

### BACKGROUND ART

Conventionally, since an elderly person with dementia may often wander in the street and get lost, a technique provides a terminal wearable by the elderly person, such as an accessory, to receive the location information and locate the elderly person (for example, Patent Document 1).

Patent Document 1: Japanese Unexamined Patent Application, Publication No. 2016-218992

### DISCLOSURE OF THE INVENTION

### Problems to be Solved by the Invention

The technique of the related art including Patent Document 1, however, has difficulty in finding elderly persons because they may rarely wear the terminal or the like for providing the location information while they are wandering. Such an issue also applies generally to those who have difficulty in conveying information indicating their current status (for example, information indicating the location).

The present invention has been made in view of the above circumstances, and an object thereof is to enable another person to easily acquire the current status of a person who has difficulty in conveying information indicating their current status to others.

### Means for Solving the Problems

In order to achieve the above object, an information processing device according to an aspect of the present invention includes:

detection means that detects a physical amount based on pressure from at least a portion of a person's foot; and
transmission means that transmits prescribed information when the physical amount detected by the detection means satisfies a prescribed standard.

The transmission means may transmit, as the prescribed information, information that is used to specify a position at which the information processing device is present.

The information processing device may be mounted on an item that is to be in contact with or in a vicinity of the person's foot, and

the detection means may detect a depressing force or a physical amount based on the depressing force.

In addition, in order to achieve the above object, an information processing system according to an aspect of the present invention includes:

a first information processing device to be mounted on an item that is to be in contact with or in a vicinity of a person's foot; and a second information processing device that executes a prescribed process related to the person,
in which the first information processing device includes detection means that detects a physical amount based on pressure from at least a portion of the person's foot, and transmission means that transmits first information when the physical amount detected by the detection means satisfies a prescribed standard, and
in which the second information processing device includes acquisition means that acquires the first information, and execution means that executes the prescribed process on the basis of the first information.

The acquisition means may further acquire second information indicating a context regarding the person in addition to the first information, and

the execution means may further execute the prescribed process on the basis of the second information in addition to the first information.

The execution means may execute the prescribed process by using a location of the person specified on the basis of the first information.

### Effects of the Invention

According to the present invention, another person can easily acquire the current status of a person who has difficulty in conveying information indicating their current status to others.

### BRIEF DESCRIPTION OF THE DRAWINGS

FIG. 1 illustrates an overview of a subject service that can be implemented by an information processing system to which the present invention is applied.

FIG. 2 illustrates an overview of an insole as an example of an item on which a transmission device to be used in the subject service in FIG. 1 is mounted.

FIG. 3 illustrates an example of a flexible substrate illustrated in FIG. 2.

FIG. 4 is an image illustrating an example of the configuration of an insole-type transmission device.

FIG. 5 illustrates the thickness of the insole-type transmission device.

FIG. 6 illustrates an overview of examples of items on which the transmission device used in the subject service in FIG. 1 is mounted, the examples being different from the example in FIG. 2.

FIG. 7 is a block diagram illustrating an example of the functional configuration of the transmission device.

FIG. 8 illustrates the configuration of the information processing system according to the present invention.

FIG. 9 is a block diagram illustrating an example of the hardware configuration of a server constituting the information processing system in FIG. 8.

FIG. 10 is a functional block diagram illustrating a functional configuration for executing an information providing process in the functional configuration of the information processing system including the server in FIG. 9.

FIG. 11 is an image illustrating a case in which the information processing system including the server having the functional configuration illustrated in FIG. 10 is applied to a wandering searching service.

FIG. 12 illustrates specific examples of current status information sent automatically as an alert notification from the server to a user terminal.

FIG. 13 is an image illustrating a case in which the information processing system including the server having the functional configuration illustrated in FIG. 10 is applied to an independence support service.

FIG. 14 is an image illustrating a case in which the information processing system including the server having the functional configuration illustrated in FIG. 10 is applied to an eyesight support service.

FIG. 15 is an image illustrating a case in which the information processing system including the server having the functional configuration illustrated in FIG. 10 is applied to a sport data providing service.

FIG. 16 is an image illustrating a case in which the information processing system including the server having the functional configuration illustrated in FIG. 10 is applied to a tracking service.

FIG. 17 is an image illustrating a case in which the information processing system including the server having the functional configuration illustrated in FIG. 10 is applied to a driving management support service.

FIG. 18 is an image illustrating a case in which the information processing system including the server having the functional configuration illustrated in FIG. 10 is applied to a factory management support service.

### PREFERRED MODE FOR CARRYING OUT THE INVENTION

Now, an embodiment of the present invention will be described with reference to the drawings.

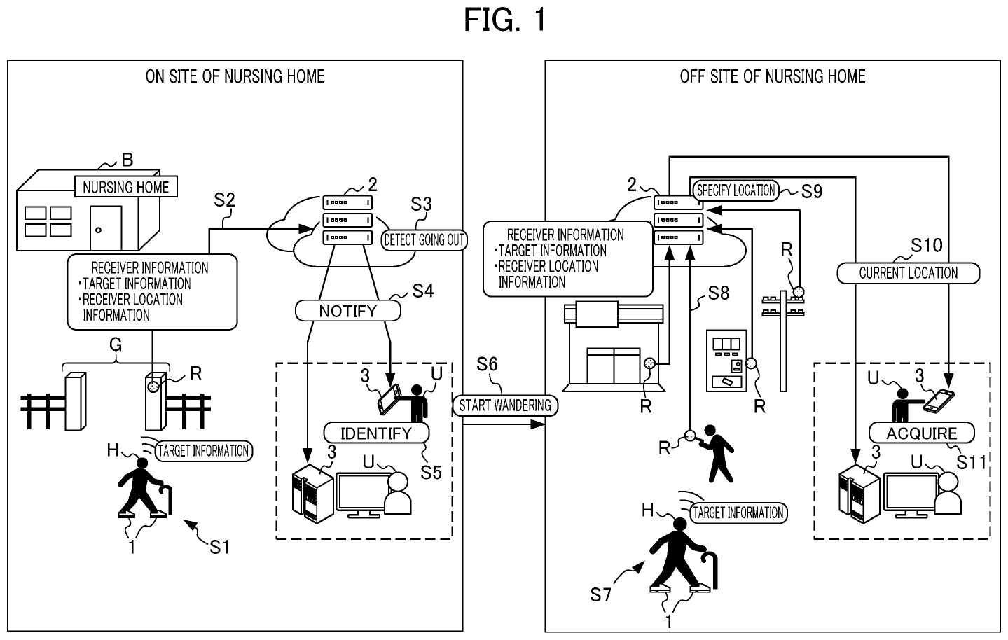

First, referring to FIG. 1, an overview of an example of a service that can be provided by an information processing system to which the present invention is applied (hereinafter referred to as “the subject service”) will be described. FIG. 1 illustrates an overview of the subject service that can be implemented by the information processing system to which the present invention is applied.

The subject service sets an elderly person with dementia as a target H and, if the target H wanders in the street and is lost, presents, to a user U, the current location of the target H and a history thereof (e.g., a wandering route). Although the user U herein may be the target H, the user U in this embodiment is a person other than the target H and is a person who wishes to know the status of the target H, such as a family member or staff at a nursing home B. The information processing system to be applied to the subject service includes a transmission device 1 to be mounted on an item (e.g., an insole) to be worn on a foot of the target H, a server 2, a receiver R, and a user terminal 3 operated by the user U. The server 2 herein is managed by a provider (not illustrated) of the subject service.

Specifically, for example, by the target H walking (precisely, depressing), the transmission device 1 transmits prescribed information (a signal). The information transmitted by the transmission device 1 can be obtained as information about the target H (hereinafter referred to as “target information”). The target information can be delivered within a prescribed distance and is thus received by the receiver R that is present within the prescribed distance from the transmission device 1 (the target H). Upon reception of a notification from the receiver R that the target information has been received, the server 2 generates the location of the receiver R as information indicating the current status of the target H (hereinafter referred to as “current status information”). The receiver R herein is fixed at an existing location in advance. Thus, by registering the location of the receiver R in advance or by receiving information indicating the location of the receiver R (hereinafter referred to as “receiver location information”) from the receiver R, the server 2 can easily identify the location of the receiver R. The server 2 transmits the current status information to the user terminal 3. By obtaining the current status information through the user terminal 3, the user U can know the current status of the target H (e.g., the current location or the wandering route).

The target H herein is not particularly limited to an elderly person and may be any person, such as a person who has difficulty in conveying information indicating their current status to others. Thus, according to the subject service, even if the target H is in a situation where it is difficult to transmit information indicating their status to others, the user U can easily acquire the information.

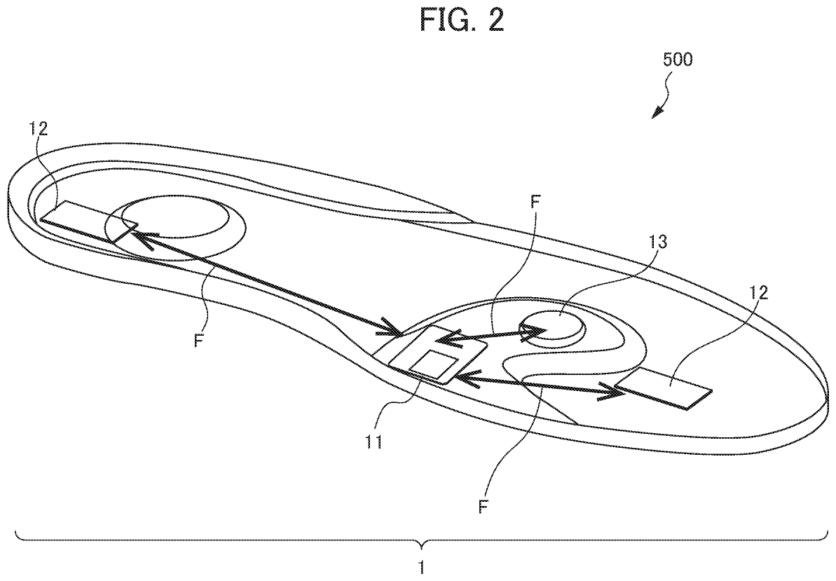

The subject service illustrated in FIG. 1 will be described in more detail. For example, in the nursing home B, a care receiver such as an elderly person is the target H. The target H may often go out without permission and wander. In such a case, even if the target H has difficulty in transmitting information indicating their status (e.g., information indicating their current location) to others, as long as they wear the transmission device 1, the current status information is generated and transmitted. This can prevent them from getting lost. Herein, an important point is that it is necessary to satisfy the condition that the target H “wears the transmission device 1”. That is, although the transmission device 1 may be a terminal such as an accessory wearable by the target H as in the related art, as described above, the target H may rarely wear the terminal or the like while wandering. Thus, with the terminal of the related art or the like, it is not possible to satisfy the condition that the target H “wears the transmission device 1”. In contrast, even while wandering, the target H is likely to wear shoes that are usually used. Accordingly, in the subject service, the transmission device 1 is mounted on an insole (e.g., an insole 500 in FIG. 2, which will be described later), in which case the insole is spread in advance (before wandering) in a shoe usually used by the target H. This satisfies the condition that the target H “wears the transmission device 1”.

That is, the transmission device 1 is mounted on an insole of a shoe worn by the target H. Thus, the target H “depresses” the insole (the transmission device 1) while wandering (walking). The transmission device 1 is capable of detecting a physical amount based on the pressure generated by the action of “depressing”. Although the physical amount based on the pressure may be the pressure itself, this embodiment employs “depressing force”. Upon the depressing force satisfying a prescribed standard such as becoming greater than or equal to a certain value as a trigger, the transmission device 1 transmits the target information (step S1).

The target information transmitted from the transmission device 1 is received by, for example, the receiver R provided for a gate G of the nursing home B and is transferred to the server 2 together with the receiver location information (step S2).

The server 2 performs analysis based on the transmitted target information and receiver location information of the receiver R provided for the gate G of the nursing home B, thereby detecting that the target H has gone out (step S3).

The server 2 notifies the user terminal 3 that the target H has gone out (step S4). The user terminal 3 displays that the target H has gone out (step S5). Thus, the user U (e.g., staff at the nursing home B) can easily know that the target H goes out.

Even if the target H wanders (step S6), the transmission device 1 can keep transmitting the target information (step S7) in accordance with the target H walking.

Herein, the receiver R that can receive the target information transmitted from the transmission device 1 can be provided in the street. For example, the receiver R may be provided at a convenience store, a vending machine, a utility pole, or a supporter terminal (e.g., a smartphone or a tablet) managed by a supporter, any location in the street or any device.

Thus, the target information transmitted from the transmission device 1 is received by any one or more of a plurality of receivers R provided in the street. Each of the receivers R that have received the target information transmits the target information and its receiver location information to the server 2 (step S8).

Through analysis based on the transmitted one or more pieces of the target information and the receiver location information, the server 2 specifies the current location of the target H (step S9).

The server 2 generates information indicating the specified current location of the target H and transmits this information as the current status information to the user terminal 3 (step S10). The user terminal 3 receives and displays the transmitted current status information including the information indicating the current location of the target H (step S11). Thus, the user U (e.g., staff at the nursing home B) can easily know the current location of the target H and a history thereof (a wandering route).

Next, a specific example of the transmission device 1 to be used in the subject service will be described. FIG. 2 illustrates an insole as an example of an item on which the transmission device to be used in the subject service is mounted.

As illustrated in FIG. 2, the transmission device 1 to be used in the subject service may be mounted on the insole 500 of a shoe. The transmission device 1 mounted on the insole 500 of a shoe (or the insole 500 on which the transmission device 1 is mounted) in this manner will be herein referred to as “insole-type transmission device 1”. The insole-type transmission device 1 is attached in advance to a shoe worn by the target H (spread inside the shoe), and thus, every time the target H depresses the shoe (the insole 500) while walking, the transmission device 1 can transmit the target information.

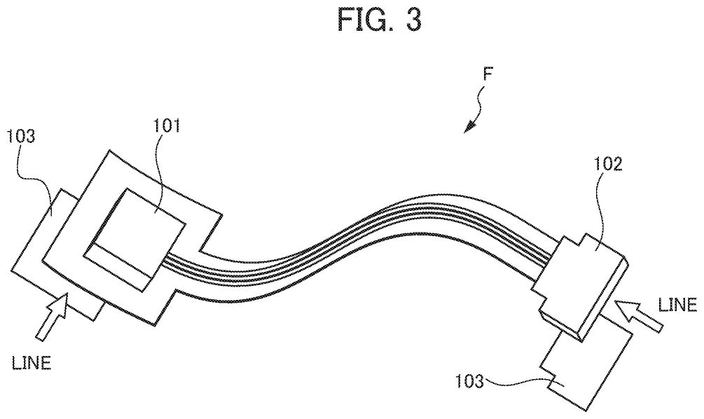

Specifically, the transmission device 1 includes a management unit 11, a detection unit 12 that detects pressure, and a power supplying unit 13. The management unit 11 is connected to the detection unit 12 via a flexible substrate F, and the management unit 11 is connected to the power supplying unit 13 via a flexible substrate F. Note that a specific embodiment of the flexible substrate F will be described later with reference to FIG. 3. Note that the array of the management unit 11, the detection unit 12, and the power supplying unit 13 illustrated in FIG. 2 is an example and is not limited to the disposition illustrated in FIG. 2. For example, on the basis of opinions of experts related to soles (e.g., insole therapists), the management unit 11 and the power supplying unit 13 may alternatively be located such that no load is applied as much as possible. In addition, the detection unit 12 is preferably disposed at a location where a load is likely to be applied. Furthermore, the disposition preferably achieves both wearability and walkability (healthy walking) of the insole 500 for the target H.

The management unit 11 is constituted by a substrate that manages the target information. A specific embodiment of the substrate constituting the management unit 11 is not limited to a particular one, but considering that the substrate is to be embedded in the insole 500, the substrate is preferably compact and sufficiently robust. Specifically, for example, the substrate constituting the management unit 11 preferably has a size of about 19 mm in length, about 26 mm in width, and about 2.6 mm in thickness.

The detection unit 12 detects a physical amount based on pressure. Specifically, the detection unit 12 detects the depressing force generated by the target H walking (the depressing action). The detection unit 12 can be constituted by a piezoelectric element as an element that converts a force applied to a piezoelectric body into a voltage. In other words, the detection unit 12 can be constituted by, for example, a piezoelectric element that converts the physical amount based on pressure into an electric signal.

The power supplying unit 13 supplies power to the management unit 11. The power supplying unit 13 is constituted by a battery or the like, and the life of the battery or the like is preferably longer than the product life of the insole 500. The product life of the insole 500 may vary according to usage but is about a year to a year and a half for daily use, such as walking, and is about six to nine months for light exercise, such as playing sport. In addition, the life is about 500 km to 1000 km for heavy exercise, such as marathon or running, and is about two to three years for low-frequency use, such as mountain climbing. Among these, the primary expected usage is daily use such as walking, and the life of the insole 500 is about a year to a year and a half. Since this value is expected from everyday use, the actual life is expected to be two to three years. Thus, to eliminate the need for exchanging or recharging the battery of the transmission device 1, a battery life of about three years is necessary. According to the present invention, a battery life exceeding three years can be achieved. Note that specific grounds for achieving a battery life exceeding three years will be described later.

A specific embodiment of the insole 500 itself is not limited to a particular one, but the insole 500 is preferably made of a material and has a shape that are resistant to water and dust entry to the substrate constituting the management unit 11.

FIG. 3 illustrates an example of the flexible substrate F illustrated in FIG. 2.

As illustrated in FIG. 3, the flexible substrate F is a substrate constituted by an electronic component 101 and a connector 102. Although not illustrated in FIG. 3, the electronic component 101 constitutes the management unit 11 in FIG. 2. The connector 102 electrically connects the management unit 11 (the electronic component 101) to the detection unit 12 and the power supplying unit 13. Each of the electronic component 101 and the connector 102 is lined with a reinforcing material 103. The flexible substrate F can be constituted by a thin and soft substrate that is bendable and foldable. Thus, even if the transmission device 1 is embedded in a material that is flexibly bendable, that is the insole 500, the transmission device 1 will not be damaged, for example.

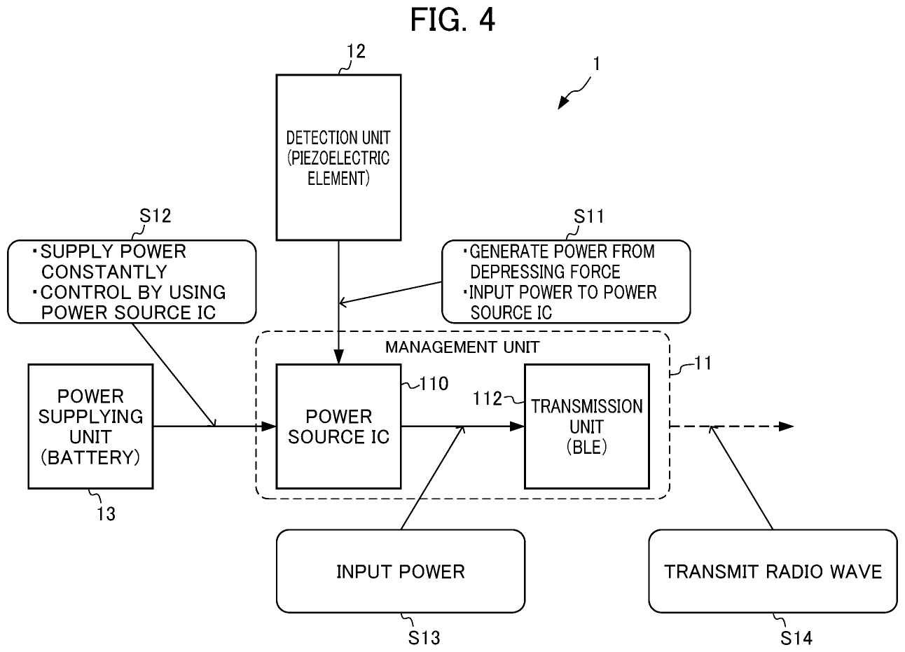

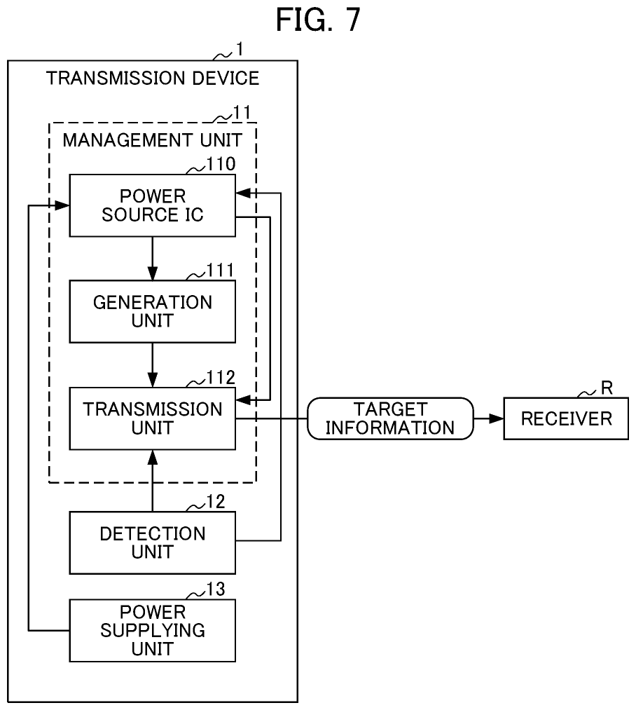

Next, with reference to FIG. 4, an operation mechanism of the insole-type transmission device 1 will be described. FIG. 4 is an image illustrating an example of the configuration of the insole-type transmission device 1. Note that the configuration illustrated in FIG. 4 is a specific example for describing an overview of the subject service, and a functional configuration of the transmission device 1 will be described later with reference to FIG. 7.

As illustrated in FIG. 4, in step S11, the detection unit (e.g., a piezoelectric element) in the transmission device 1 generates power from the depressing force of the target H and inputs the power to a power source IC 110.

In step S12, the power supplying unit 13 (e.g., a battery) constantly supplies power to the power source IC 110. Note that the power supply from the power supplying unit 13 to the power source IC 110 is controlled by the power source IC 110.

In step S13, the power source IC 110 inputs power to a transmission unit 112. In step S14, the transmission unit 112 transmits a radio wave on which the target information is superimposed. The transmission unit 112 herein preferably employs, for example, a low-power-consumption communication method, such as BLE (Blue Tooth Low Energey) (registered trademark). Herein, even if the transmission unit 112 employs a low-power-consumption communication method, such as BLE, if a conventionally used beacon performs transmission per second, the battery life may become about eight months to a year. That is, in a case where the capacity of the battery is 165 mAh and the power consumption per transmission from the beacon is 80 μWs, the battery life becomes 257.8 days. In contrast, in a case of the above-described configuration (using a piezoelectric element), since the power consumption can be suppressed, the battery life is dramatically increased to about three to seven years. That is, in a case where the average number of daily steps of the target H is 10800 and a radio wave for live monitoring is generated every 30 seconds for monitoring, the battery life becomes 2690.22 days. Thus, since the life of the power supplying unit 13 can be dramatically increased, it is possible to employ a material that increases the life of the insole 500 while satisfying the condition that the life of the power supplying unit 13 is longer than the life of the insole 500. Note that a specific size of the transmission unit 112 is not limited to a particular one. For example, in a case where the transmission unit 112 is a BLE module, it is possible to set about 7.9 mm in length and about 11.5 mm in width. In addition, the entire thickness of the management unit 11 including the BLE module is preferably about 2.6 mm.

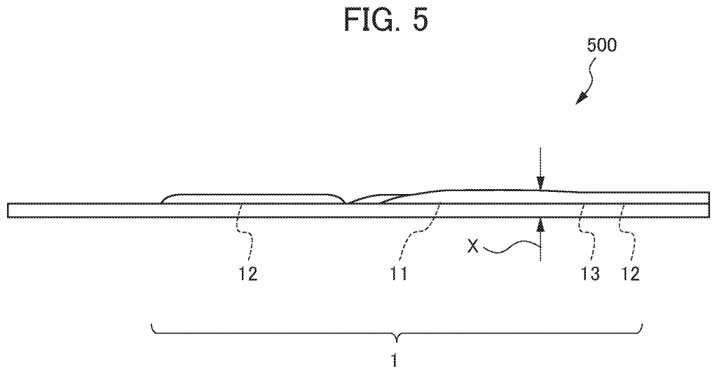

FIG. 5 illustrates the thickness of the insole-type transmission device 1.

As equipment for searching for a wandering person of the related art, a shoe including GPS (Global Positioning System) equipment is provided. However, considering the size, strength, or the like of the GPS, a thick insole integrated with the shoe is used, and part of the insole is hollowed out to have the GPS equipment inserted therein. Thus, the equipment for searching for a wandering person of the related art is only used as a dedicated shoe, which narrows down the options for shoes of the target H. In addition, with the unnatural, unstable thick sole, the shoe cannot ensure safe, stable walking of elderly persons. Furthermore, the battery needs to be exchanged or recharged frequently, and the equipment may be unexpectedly out of power, which is not preferable as a product for monitoring.

Accordingly, the insole-type transmission device 1 has a thickness X of about 10 mm. This provides the target H with a degree of wearing freedom and may be applied to various shoes (footwear). That is, the insole-type transmission device 1 may be attached to a shoe that is usually worn by the target H.

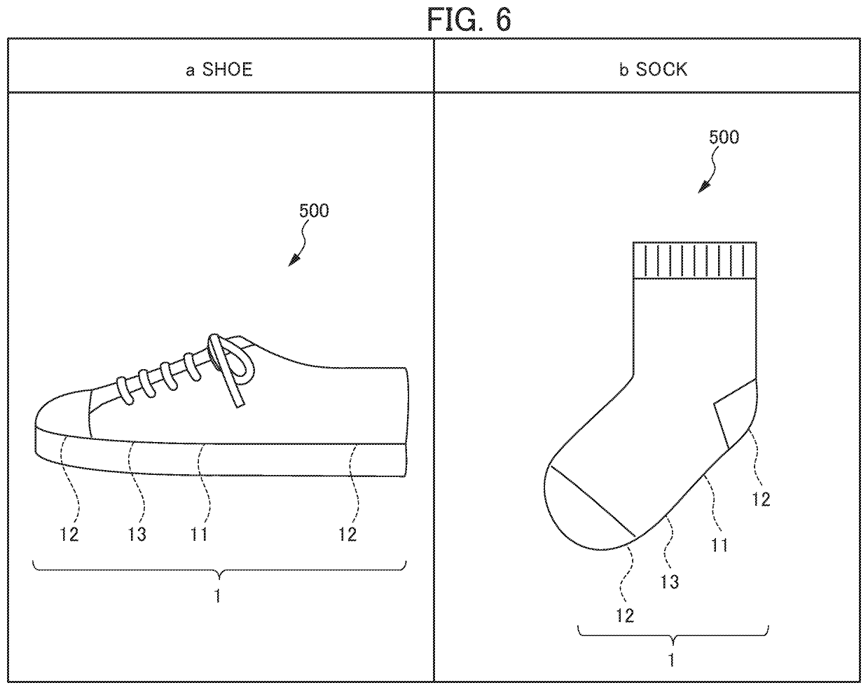

Next, an example in which the transmission device 1 is formed by using an item 500 other than the insole 500 will be described. FIG. 6 illustrates an overview of examples of items on which the transmission device used in the subject service in FIG. 1 is mounted, the examples being different from the example in FIG. 2.

In “a: shoe” in the example illustrated in FIG. 6, a shoe 500 is employed as the item 500 for forming the transmission device 1. That is, in “a: shoe” in the example illustrated in FIG. 6, instead of attaching the insole-mounted transmission device 1 to the shoe 500 (spreading the insole-mounted transmission device 1 in the shoe 500), the shoe itself functions as the item 500 on which the transmission device 1 is mounted.

In “b: sock” in the example illustrated in FIG. 6, a sock 500 is employed as the item 500 on which the transmission device 1 is mounted. That is, in “b: sock” in the example illustrated in FIG. 6, the sock itself functions as the item 500 on which the transmission device 1 is mounted. This may address wandering in an environment for which shoes are not worn. As the environment for which shoes are not worn, for example, a spacious room or going out without shoes may be expected.

### [Functional Configuration]

FIG. 7 is a block diagram illustrating an example of the functional configuration of the transmission device 1.

The transmission device 1 includes the management unit 11, the detection unit 12, and the power supplying unit 13.

The management unit 11 includes the power source IC 110, a generation unit 111, and the transmission unit 112. Upon power being input from the detection unit 12 as a trigger, the power source IC 110 inputs power to the generation unit 111 and the transmission unit 112. The generation unit 111 generates target information by using the power input from the power source IC 110. By using the power input from the power source IC 110, the transmission unit 112 transmits the target information generated by the generation unit 111. The target information transmitted from the transmission unit 112 is received by the receiver R.

The detection unit 12 generates power from the depressing force of the target H and inputs the power to the power source IC 110.

The power supplying unit 13 constantly supplies power to the power source IC 110. Note that the power supply from the power supplying unit 13 to the power source IC 110 is controlled by the power source IC 110.

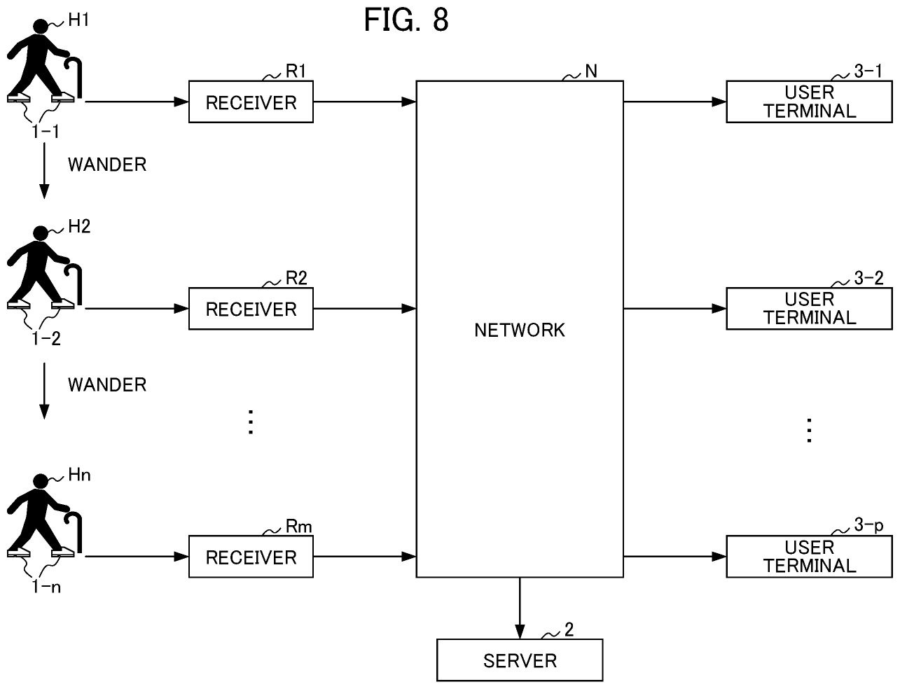

Next, the configuration of the information processing system including the transmission device 1 illustrated in FIG. 1 to FIG. 7 will be described. FIG. 8 illustrates the configuration of the information processing system according to the present invention.

The information processing system according to FIG. 8 includes the transmission device 1, the server 2, receivers R1 to Rm (m is an integer greater than or equal to 1), and user terminals 3-1 to 3-p (p is an integer greater than or equal to 1). Note that only a single target H and a single transmission device 1 are depicted in the example in FIG. 8. This, however, is for understanding time-series motion (wandering) of the target H, and actually, although not illustrated, targets H1 to Hn (n is an integer greater than or equal to 1) and transmission devices 1-1 to 1-n may exist. The transmission device 1 and the receivers R1 to Rm may be connected to each other by prescribed wireless communication including near-field communication, such as BLE. The server 2, each of the receivers R1 to Rm, and each of the user terminals 3-1 to 3-p are mutually connected via a prescribed network N such as the Internet. Although not illustrated, a target terminal 4 operated by the target H is also mutually connected via the network N.

### (Transmission Device)

The transmission device 1 is a device mounted on the insole 500 of a shoe worn by the target H. Specifically, in response to the depressing force of the target H, the transmission device 1 transmits target information. The transmission device 1 is constituted by, for example, a beacon.

### (Receiver)

The receivers R1 to Rm receive the target information transmitted from the transmission device 1 and transfer the target information together with their receiver location information to the server 2. Hereinafter, unless it is necessary to distinguish the receivers R1 to Rm from each other, the receivers R1 to Rm are collectively referred to as “receivers R”.

### (Server)

The server 2 is an information processing device managed by a service provider, which is not illustrated. The server 2 executes various processes to implement the subject service while communicating with the receivers R1 to Rm and the user terminals 3-1 to 3-p as appropriate. In addition, through analysis based on the target information and the receiver location information, the server 2 detects that the target H goes out. Furthermore, the server 2 notifies the user terminal 3 that the target H goes out.

### (User Terminal)

The user terminals 3-1 to 3-p are information processing devices operated by users Ul to Up, respectively (FIG. 1). Each of the user terminals Ul to Up is constituted by a personal computer, a smartphone, a tablet, or the like. Each of the user terminals 3-1 to 3-p receives an input operation necessary for each of the users Ul to Up to use the subject service and transmits information indicating the input content to the server 2. In addition, each of the user terminals 3-1 to 3-p displays various kinds of information transmitted from the server 2 automatically or under control of the server 2.

A dedicated application to be provided with the subject service is installed on each of the user terminals 3-1 to 3-p. Unless otherwise specified, hereinafter, the expression “the user U operates the user terminal 3” means that the user U starts the dedicated application installed on the user terminal 3 and performs various operations. Hereinafter, if the users Ul to Up are not distinguished from each other and are referred to as “users U”, the respective user terminals 3-1 to 3-p will be collectively referred to as the respective “user terminals 3”. In addition, unless it is necessary to distinguish the receivers R1 to Rm from each other, these will be collectively referred to as “receivers R”.

Since the information processing system including the transmission device 1 has the above configuration, the service provider (not illustrated) can provide a service highly convenient for each of the users U and the target H.

### [Hardware Configuration]

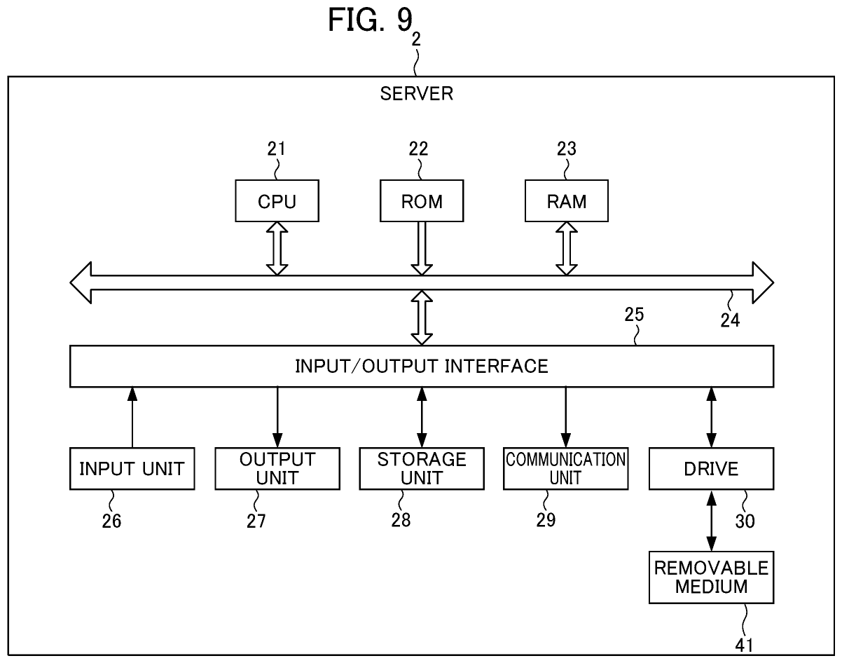

Next, the hardware configuration of the transmission device 1 and the server 2 constituting the information processing system in FIG. 7 will be described with reference to FIGS. 8 and 9.

### (Server)

FIG. 9 is a block diagram illustrating an example of the hardware configuration of the server 2 constituting the information processing system in FIG. 8.

The server 2 includes a CPU (Central Processing Unit) 21, a ROM (Read Only Memory) 22, a RAM (Random Access Memory) 23, a bus 24, an input/output interface 25, an input unit 26, an output unit 27, a storage unit 28, a communication unit 29, and a drive 30.

The CPU 21 executes various processes in accordance with a program recorded in the ROM 22 or a program loaded from the storage unit 28 to the RAM 23. The RAM 23 stores, as appropriate, data or the like necessary for the CPU 21 to execute various processes.

The CPU 21, the ROM 22, and the RAM 23 are mutually connected via the bus 24. The input/output interface 25 is also connected to the bus 24. The input unit 26, the output unit 27, the storage unit 28, the communication unit 29, and the drive 30 are connected to the input/output interface 25.

The input unit 26 is constituted by various hardware buttons or the like and receives various kinds of information in accordance with an operator's command operations. The output unit 27 is constituted by a display such as a liquid crystal display and displays various images.

The storage unit 28 is constituted by a DRAM (Dynamic Random Access Memory) or the like and stores various kinds of data. The communication unit 29 controls communication with another device (the receivers R1 to Rm and the user terminals 3-1 to 3-p) via the network N including the Internet.

The drive 30 is provided as necessary. A removable medium 41 is attached to the drive 30 as appropriate, and the removable medium 41 is formed of a magnetic disk, an optical disk, a magneto-optical disk, a semiconductor memory, or the like. The program read from the removable medium 41 by the drive 30 is installed in the storage unit 28 as necessary. In addition, the removable medium 41 can also store various kinds of data stored in the storage unit 28 in the same manner as the storage unit 28.

Although not illustrated, in the information processing system in FIG. 8, the receivers R, the user terminals 3, and the target terminal 4 (not illustrated) also have the hardware configuration illustrated in FIG. 9. If the user terminals 3 and the target terminal 4 are smartphones or tablets, the input unit 26 and the output unit 27 have a touch panel.

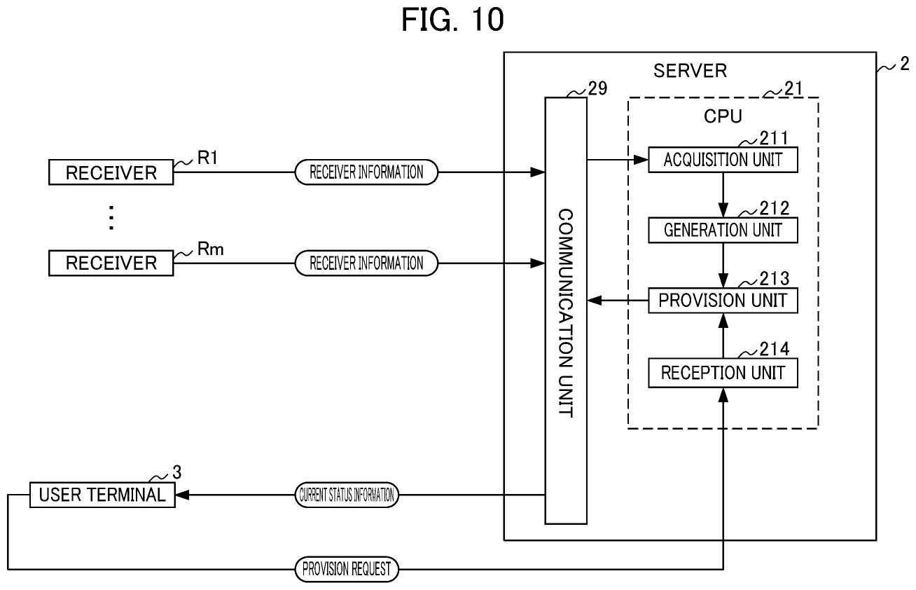

Collaboration of various hardware components of the server 2 illustrated in FIG. 9 and various software components enables the server 2 to execute various processes including an information generating process and an information providing process. As a result, a service provider can provide the above-described subject service. The term “information generating process” refers to a process in which the server 2 generates information indicating the location and state of the target H on the basis of the acquired target information and receiver location information. The term “information providing process” refers to a process in which the server 2 provides the generated information indicating the location and state of the target H to the user U. Now, the functional configuration for executing the information generating process performed by the server 2 will be described with reference to FIG. 10.

### [Functional Configuration]

FIG. 10 is a functional block diagram illustrating a functional configuration for executing the information providing process in the functional configuration of the information processing system including the server 2 in FIG. 8.

As illustrated in FIG. 10, in a case where execution of the information generating process is controlled, an acquisition unit 211 and a generation unit 212 function in the CPU 21 of the server 2. In a case where execution of the information providing process is controlled, a provision unit 213, and a reception unit 214, as necessary, function.

The acquisition unit 211 acquires receiver information transmitted from each of the receivers R1 to Rm. Note that the term “receiver information” herein refers to information including the target information and the receiver location information that are transmitted from the transmission device 1 and received by the receivers R.

The generation unit 212 generates information indicating the status of the target H (hereinafter referred to as “current status information”) on the basis of the receiver information acquired by the acquisition unit 211. Specifically, the generation unit 212 analyzes the receiver information to generate the current status information.

The reception unit 214 receives information indicating a request for providing the current status information of the target H (hereinafter referred to as “provision request”) transmitted from each of the user terminals 3-1 to 3-p.

The provision unit 213 transmits each piece of the current status information generated by the generation unit 212 to each of the user terminals 3-1 to 3-p. Specifically, if the reception unit 214 receives a provision request, the provision unit 213 transmits the current status information for the provision request to the user terminals 3. In addition, without any condition of a provision request, the server 2 may independently make a determination to transmit the current status information.

The server 2 having the above functional configuration can execute processes including the information providing process. This enables a service provider to provide the highly convenient subject service to the user U and the target H.

### [Application Examples]

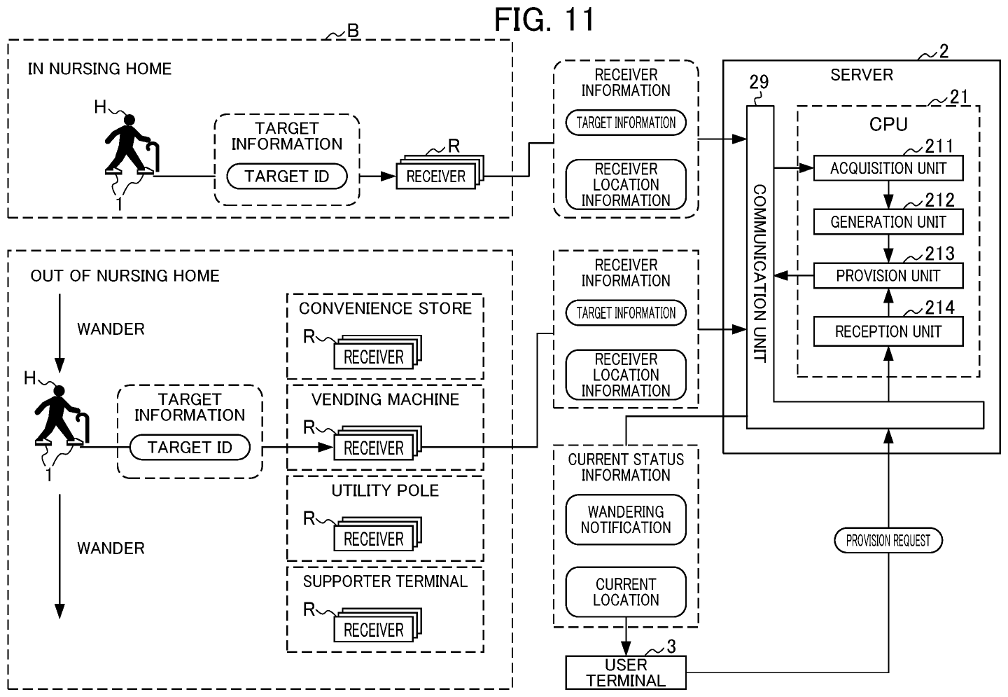

Next, application examples of the information processing system including the server 2 having the functional configuration illustrated in FIG. 10 will be described with reference to FIGS. 11 to 18. FIG. 11 is an image illustrating a case in which the information processing system including the server 2 having the functional configuration illustrated in FIG. 10 is applied to a wandering searching service.

As illustrated in FIG. 11, if the target H who wears the transmission device 1 is walking on the site of the nursing home B, the target information transmitted from the transmission device 1 is received by a receiver R provided on the site of the nursing home B. The target information received by the receiver R is transmitted to the server 2 together with the receiver location information as the receiver information. Then, the server 2 acquires the transmitted receiver information, executes the above-described information providing process, and transmits the current status information to the user terminal 3. Thus, on the basis of the current status information transmitted to the user terminal 3, the user U can easily know that the target H is on the site of the nursing home B.

In addition, as illustrated in FIG. 11, if the target H who wears the transmission device 1 is not on the site of the nursing home B (wandering), the target information transmitted from the transmission device 1 is received by each of the receivers R provided off the site of the nursing home B. As illustrated in FIG. 11, the receivers R may be provided at or mounted on a convenience store, a vending machine, a utility pole, or a supporter terminal (e.g., a smartphone or a tablet) managed by a supporter. The target information received by the receivers R is transmitted to the server 2 together with the receiver location information as the receiver information. Then, the server 2 acquires the transmitted receiver information, executes the above-described information providing process, and transmits the current status information to the user terminal 3. The current status information transmitted from the server 2 to the user terminal 3 herein includes information such as an alert notification indicating that the target H is wandering. Thus, on the basis of the current status information automatically sent as an alert notification, the user U can immediately know that the target H is outside the facility of the nursing home B (wandering) without performing an operation for transmitting a provision request to the server 2.

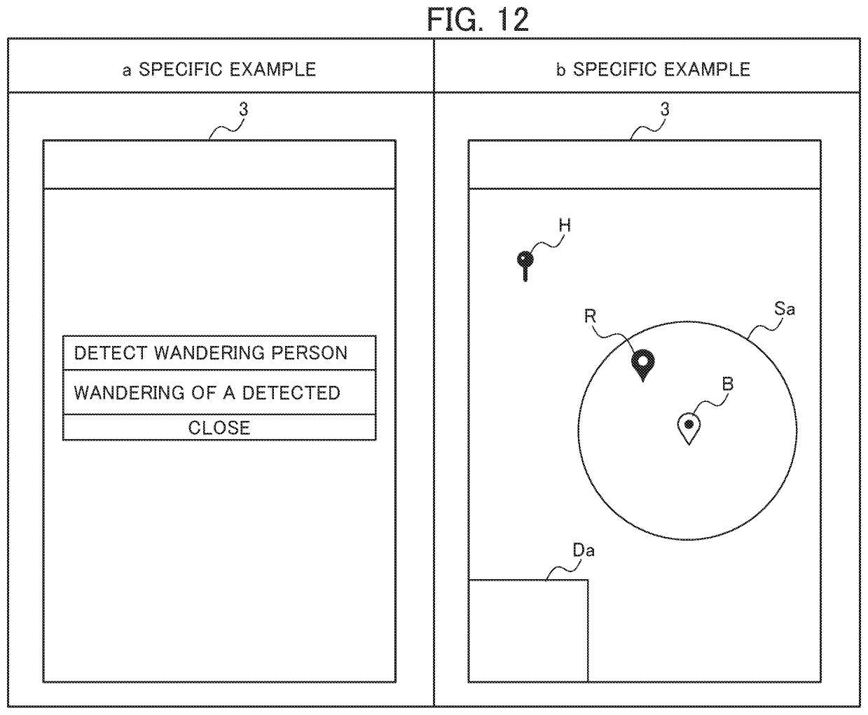

FIG. 12 illustrates specific examples of the current status information sent automatically as an alert notification from the server 2 to the user terminal 3.

As described above, the subject service includes a service for detecting wandering of the target H. FIG. 12 illustrates “a: specific example”, which is a specific example in which the screen of the user terminal 3 displays a message indicating that wandering is detected. That is, upon wandering of the target H being detected by the server 2, the screen of the user terminal 3 displays a pop-up message indicating “wandering person detected” or “wandering of A (target H) detected”, for example. The pop-up message displayed on the screen of the user terminal 3 can be closed by pressing the button displayed as “close”.

FIG. 12 illustrates “b: specific example”, which is a specific example in which the screen of the user terminal 3 displays a map indicating the location of the wandering person. That is, upon wandering of the target H being detected by the server 2, the screen of the user terminal 3 displays, together with the map, information indicating the current location of the target H detected as the wandering person, information indicating the location of the nursing home B, information indicating a safe region Sa as a region in which the target H is present, information indicating the location of the receiver R, a region Da where prescribed information is displayable, and the like.

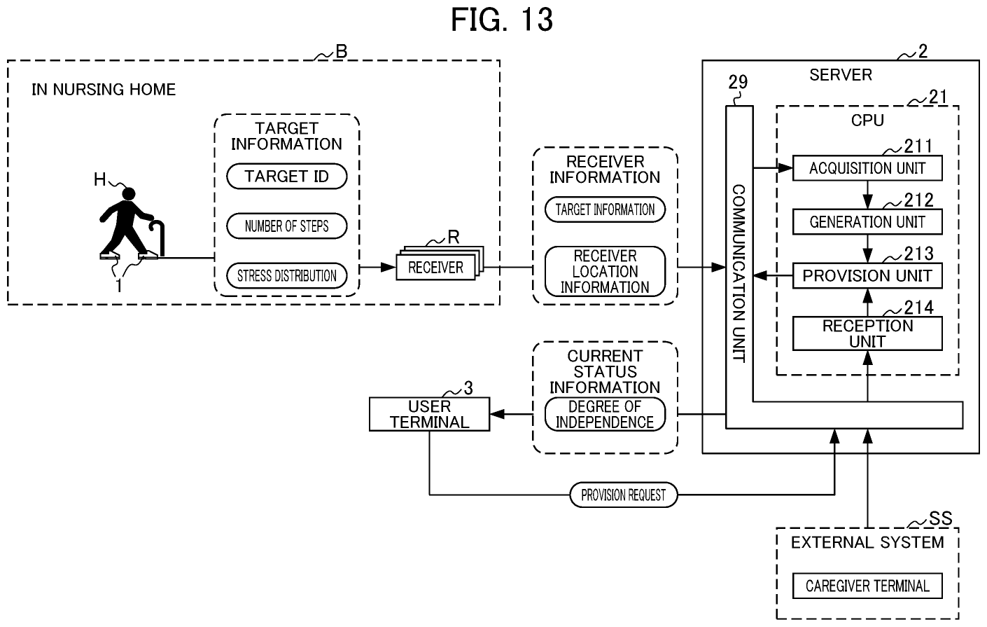

FIG. 13 is an image illustrating a case in which the information processing system including the server 2 having the functional configuration illustrated in FIG. 10 is applied to an independence support service.

The subject service includes a service for supporting the independence of the target H (hereinafter referred to as “independence support service”). As illustrated in FIG. 13, if the target H who wears the transmission device 1 is walking on the site of the nursing home B, the target information transmitted from the transmission device 1 is received by a receiver R provided on the site of the nursing home B.

The target information herein may include context information of the target H. The concept “context” indicates all the internal and external states of the target H. The internal state of the target H indicates the physical condition, emotions (mood or psychological condition), or the like of the target H. The external state of the target H indicates, in addition to the special or temporal arrangement of the target H (the temporal arrangement refers to, for example, the current time), a prescribed state distributed in the special or temporal direction (or both) near the target H. The context information may include, for example, information regarding the activity of the target H (e.g., the number of steps), information regarding the stress, information regarding the environment, subjective information regarding the physical condition, objective information regarding physical features of the target H, such as age, height, weight, body temperature, and body fat ratio, and information regarding the schedule of the target H, such as an activity history of the target H. A specific method for the server 2 to acquire the context information herein is not limited to a particular one. For example, information provided from an external server may be acquired as the context information, or the transmission device 1 may include various sensors (not illustrated) and acquire information detected by these sensors as the context information. In addition, information that is separately managed at a facility or the like managed by the user U, such as the nursing home B, may be acquired as the context information.

The target information received by the receiver R is transmitted to the server 2 together with the receiver location information as the receiver information. Then, the server 2 acquires the transmitted receiver information, executes the above-described information providing process to generate the current status information, and transmits the current status information to the user terminal 3.

Specifically, the server 2 acquires, together with the receiver location information, the target information including at least information for uniquely identifying the target H (hereinafter referred to as “target ID”), information regarding the number of steps of the target H (hereinafter referred to as “number of steps information”), and information regarding stress distribution (stress distribution information).

The server 2 herein executes the above-described information providing process to generate the current status information. In the example in FIG. 13, the generated current status information includes information indicating “degree of independence” of the target H. The index “degree of independence” indicates the degree to which the target H can spend daily life without depending on others. The degree of independence can be calculated on the basis of the context information included in the target information. Specifically, for example, information managed by an external system SS managed by the nursing home B and information detected by various sensors (not illustrated) of the transmission device 1 are acquired as the context information, and the degree of independence is calculated on the basis of the context information. The server 2 transmits information indicating the calculated degree of independence of the target H to the user terminal 3. Thus, on the basis of the current status information including the information indicating the degree of independence, transmitted to the user terminal 3, the user U can easily know the current status of the target H.

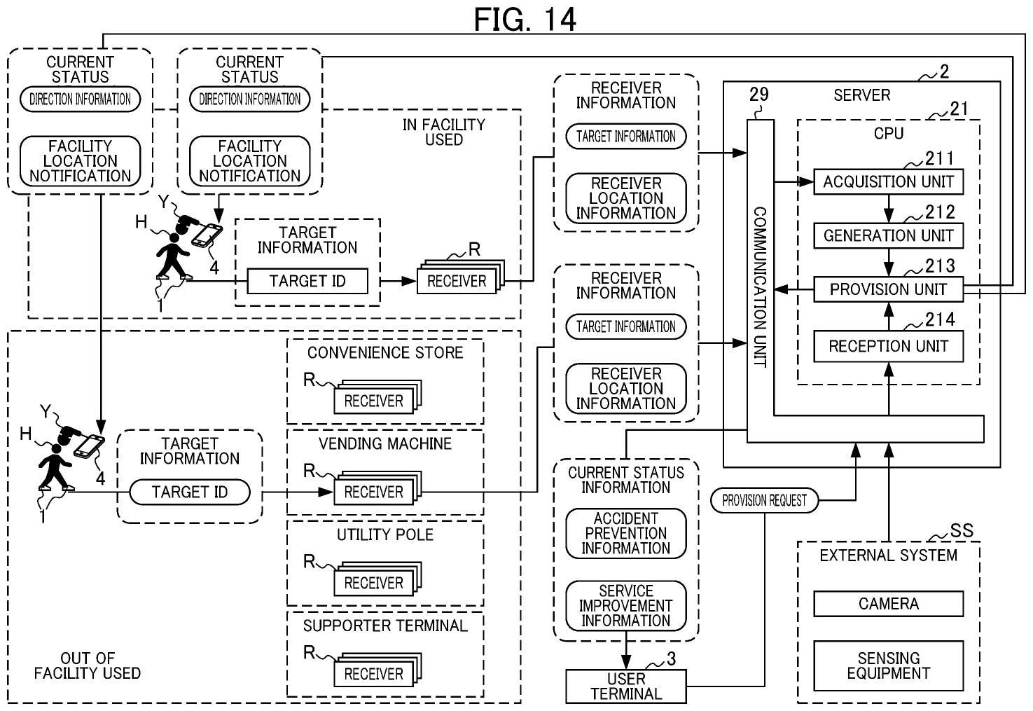

FIG. 14 is an image illustrating a case in which the information processing system including the server 2 having the functional configuration illustrated in FIG. 10 is applied to an eyesight support service.

The subject service includes a service for supporting the target H who has a disability in eyesight, such as weak eyesight, (hereinafter referred to as “eyesight support service”). As illustrated in FIG. 14, the target H who is provided with the eyesight support service carries the target terminal 4 with them and acquires the current status information with the target terminal 4. Specifically, for example, the target H can acquire the current status information by hearing through earphones Y connected to the target terminal 4.

First, if the target H who wears the transmission device 1 is walking on the site of the nursing home B, the target information transmitted from the transmission device 1 is received by a receiver R provided on the site of the nursing home B.

The target information herein includes the context information of the target H acquired by the above method. The target information including the context information, received by the receiver R, is transmitted to the server 2 together with the receiver location information as the receiver information. Then, the server 2 acquires the transmitted receiver information, executes the above-described information providing process to generate the current status information, and transmits the current status information to the target terminal 4 and the user terminal 3.

The server 2 herein acquires, in addition to the receiver information, information necessary for supporting the eyesight of the target H (hereinafter “eyesight support information”) from the external system SS, and, on the basis of the acquired information, executes the above-described information providing process. The external system SS includes an image pick-up means capable of picking up an image of the target H (e.g., a camera), sensing equipment capable of acquiring information indicating the state of the target H, and the like. Thus, “eyesight support information” includes data of the picked-up image of the target H picked up by the image pick-up means of the external system SS and information indicating the state of the target H detected by the sensing equipment.

On the basis of the receiver information and the eyesight support information, the server 2 generates the current status information. In the example in FIG. 14, the generated current status information includes information for preventing the target H from accidents (hereinafter referred to as “accident prevention information”) and information for improving a nursing service for the target H by a caregiver (hereinafter referred to as “service improvement information”). The server 2 transmits the generated current status information including the accident prevention information and the service improvement information to the target terminal 4 and the user terminal 3 as appropriate. Thus, relying on the current status information including the accident prevention information, transmitted to the target terminal 4, the target H can spend a daily life. In addition, on the basis of the current status information including the service improvement information, transmitted to the user terminal 3, the user U can easily acquire information necessary for improving the service.

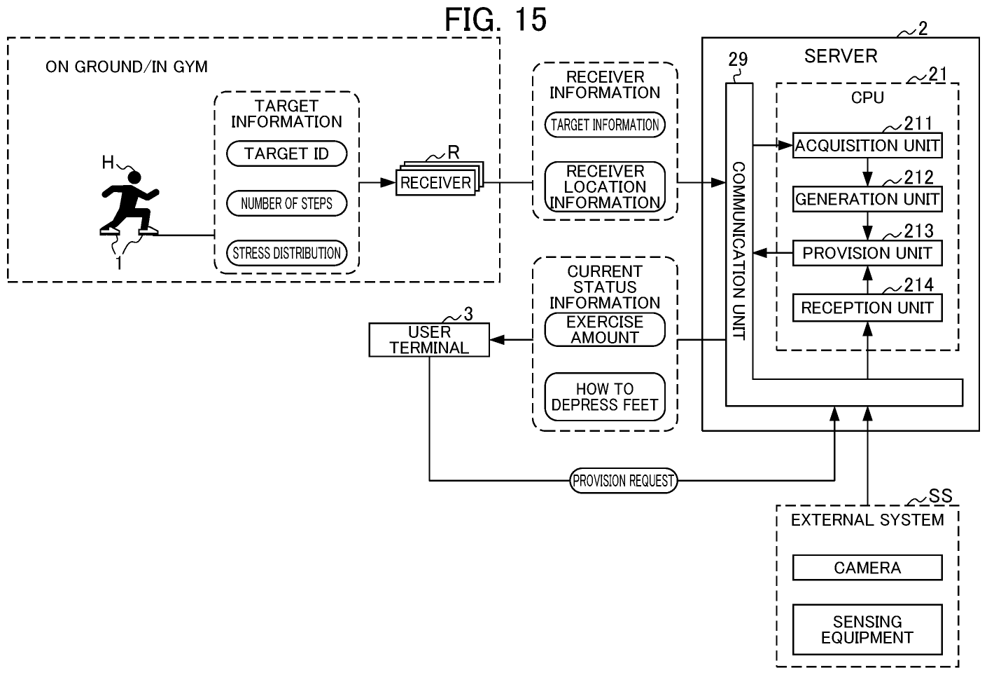

FIG. 15 is an image illustrating a case in which the information processing system including the server 2 having the functional configuration illustrated in FIG. 10 is applied to a sport data providing service.

The subject service includes a service for supporting the user U (e.g., a coach) who supports the target H who is a sport player (hereinafter referred to as “sport data providing service”). As illustrated in FIG. 15, the user U who is provided with the sport data providing service wears a sports shoe 500 on which the transmission device 1 is mounted to play sports. For example, in a case where the target H is a marathon runner, the target H running causes the transmission device 1 to transmit the target information. The target information transmitted from the target H herein includes at least the target ID, the number of steps information, and the stress distribution information.

If the target H plays sport on a ground or in a gym, for example, the target information transmitted from the transmission device 1 is received by a receiver R provided on the site of the nursing home B. The target information including the context information, received by the receiver R, is transmitted to the server 2 together with the receiver location information as the receiver information. Then, the server 2 acquires the transmitted receiver information, executes the above-described information providing process to generate the current status information, and transmits the current status information to the target terminal 4 (not illustrated) and the user terminal 3.

The server 2 herein acquires, in addition to the receiver information, information for supporting the user U who supports the target H playing sport as the context information from the external system SS, and, on the basis of the acquired information, executes the above-described information providing process. The external system SS includes an image pick-up means capable of picking up an image of the target H (e.g., a camera), sensing equipment capable of acquiring information indicating the state of the target H, and the like. Thus, the context information provided by the external system SS includes data of the picked-up image of the target H picked up by the image pick-up means of the external system SS and information indicating the state of the target H detected by the sensing equipment.

On the basis of the receiver information and the context information provided by the external system SS, the server 2 generates the current status information. In the example in FIG. 15, the generated current status information includes information indicating the exercise amount of the target H (hereinafter referred to as “exercise amount information”) and technical information about, for example, how the target H depresses their feet (hereinafter referred to as “technical information”). If the target H is a professional figure skater, as the technical information, for example, information obtained by comparison with top-rank professional information (model information) about how to depress their feet at the time of pushing down for jump is generated. The server 2 transmits the generated current status information including the exercise amount information and the technical information in response to a provision request from the user terminal 3 as appropriate. Thus, referring to the current status information including the exercise amount information and the technical information, transmitted from the server 2 to the user terminal 3, the user U can appropriately support the target H.

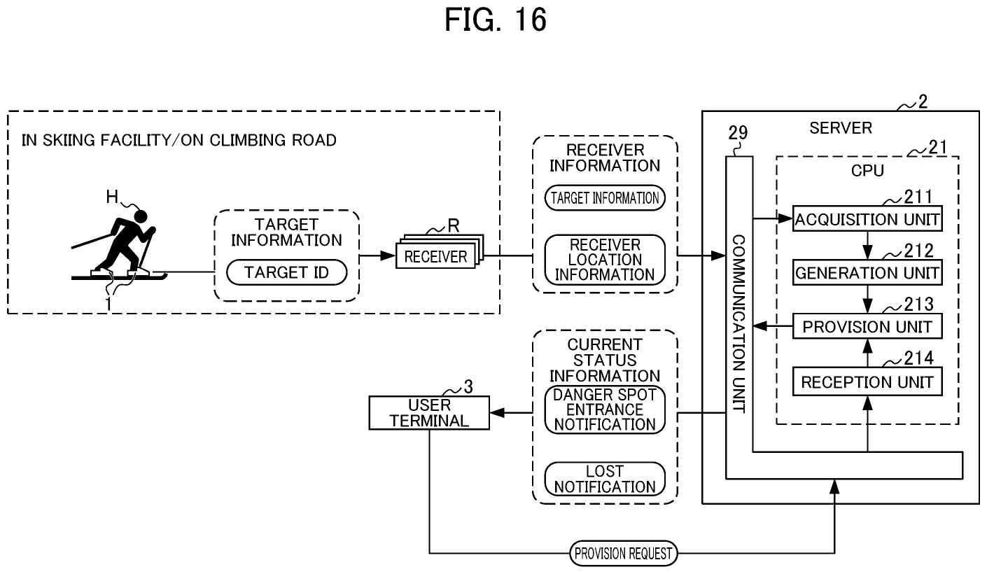

FIG. 16 is an image illustrating a case in which the information processing system including the server 2 having the functional configuration illustrated in FIG. 10 is applied to a tracking service.

The subject service includes a service for supporting a management service of a manager or the like of a skiing facility or the like by tracking a user of the skiing facility or a climber (hereinafter referred to as “tracking service”). As illustrated in FIG. 16, according to the tracking service, the target H who is a target to be tracked (the user of the skiing facility or the climber) wears a ski shoe or a climbing shoe on which the transmission device 1 is mounted to play ski or to climb. For example, in a case where the target H is a climber, the target H walking causes the transmission device 1 to transmit the target information. The target information transmitted from the target H herein includes at least information that is used to specify the location of the transmission device 1 (e.g., a beacon signal).

If the target H plays ski or climbs on a mountain, the target information transmitted from the transmission device 1 is received by a receiver R provided on the site of the skiing facility or a climbing road. The target information received by the receiver R is transmitted to the server 2 together with the receiver location information as the receiver information. Then, the server 2 acquires the transmitted receiver information, executes the above-described information providing process to generate the current status information, and transmits the current status information to the target terminal 4 (not illustrated) and the user terminal 3.

On the basis of the receiver information, the server 2 generates the current status information. In the example in FIG. 16, the generated current status information includes information indicating the location of the target H. In addition, if the target H enters a danger spot or is lost, alert information or the like is generated as the current status information. The server 2 transmits the generated current status information including the information indicating the location of the target H and the alert information to the user terminal 3 as appropriate. Thus, on the basis of the current status information transmitted from the server 2 to the user terminal 3, the user U can appropriately address the situation.

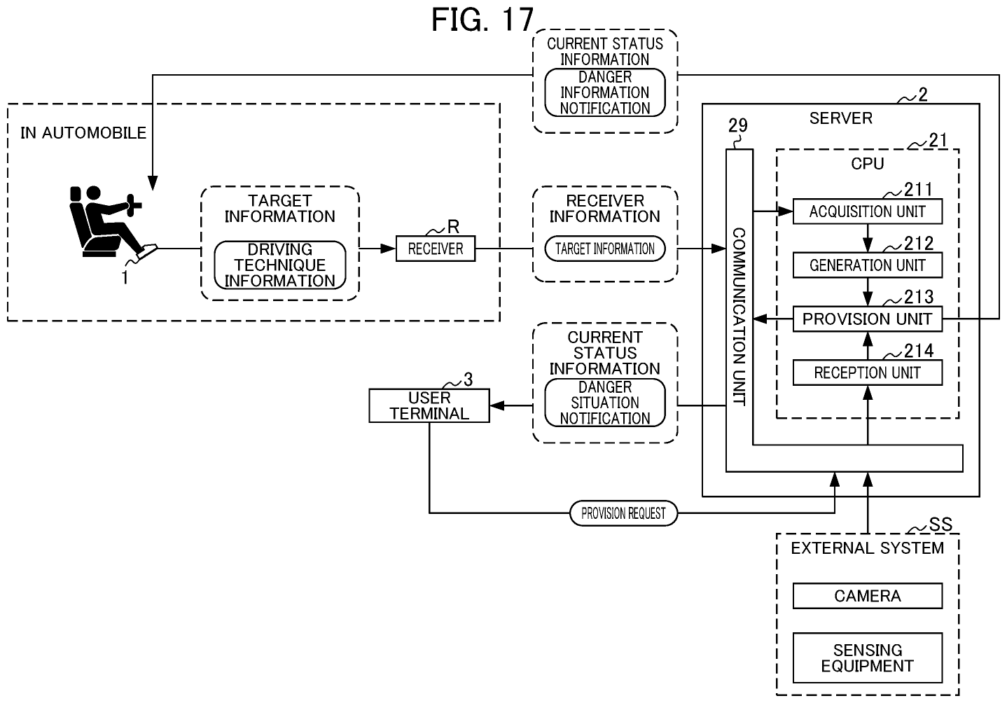

FIG. 17 is an image illustrating a case in which the information processing system including the server 2 having the functional configuration illustrated in FIG. 10 is applied to a driving management support service.

The subject service includes a service for supporting a person (the user U) who manages the target H driving by detecting acceleration work of the target H who drives an automobile, including prevention of traffic accidents (hereinafter referred to as “driving management support service”). As illustrated in FIG. 17, according to the driving management support service, the target H who is a target to be managed wears a shoe on which the transmission device 1 is mounted to drive an automobile. Thus, for example, the target H depressing an accelerator pedal or a brake pedal causes the transmission device 1 to transmit the target information.

If the target H drives an automobile, the target information transmitted from the transmission device 1 is received by a receiver R provided in the automobile. The target information received by the receiver R is transmitted to the server 2 together with the receiver location information as the receiver information. Then, the server 2 acquires the transmitted receiver information, executes the above-described information providing process to generate the current status information, and transmits the current status information to the target terminal 4 (not illustrated) and the user terminal 3.

The server 2 herein acquires, in addition to the receiver information, information for supporting the person (the user U) who manages driving of the target H as the context information from the external system SS, and, on the basis of the acquired information, executes the above-described information providing process. The external system SS includes an image pick-up means capable of picking up an image of the target H who drives an automobile (e.g., a camera), sensing equipment capable of acquiring information indicating the state of the target H, and the like. Thus, the context information provided by the external system SS includes data of the picked-up image of the target H picked up by the image pick-up means of the external system SS and information indicating the state of the target H detected by the sensing equipment.

On the basis of the receiver information and the context information provided by the external system SS, the server 2 generates the current status information. In the example in FIG. 17, the generated current status information includes information regarding a driving technique of the target H including acceleration work (hereinafter referred to as “driving technique information”) and character information of the target H (hereinafter referred to as “character information”). In addition, if the target H is in a danger situation, alert information or the like is generated as the current status information. The server 2 transmits the generated current status information including the driving information and the technique information in response to a provision request from the user terminal 3 as appropriate. In addition, the alert information is transmitted regardless of the presence or absence of a provision request from the user terminal 3. Thus, referring to the current status information including the driving technique information, the character information, and the alert information, transmitted from the server 2 to the user terminal 3, the person (the user U) who manages the target H driving can appropriately manage the target H driving.

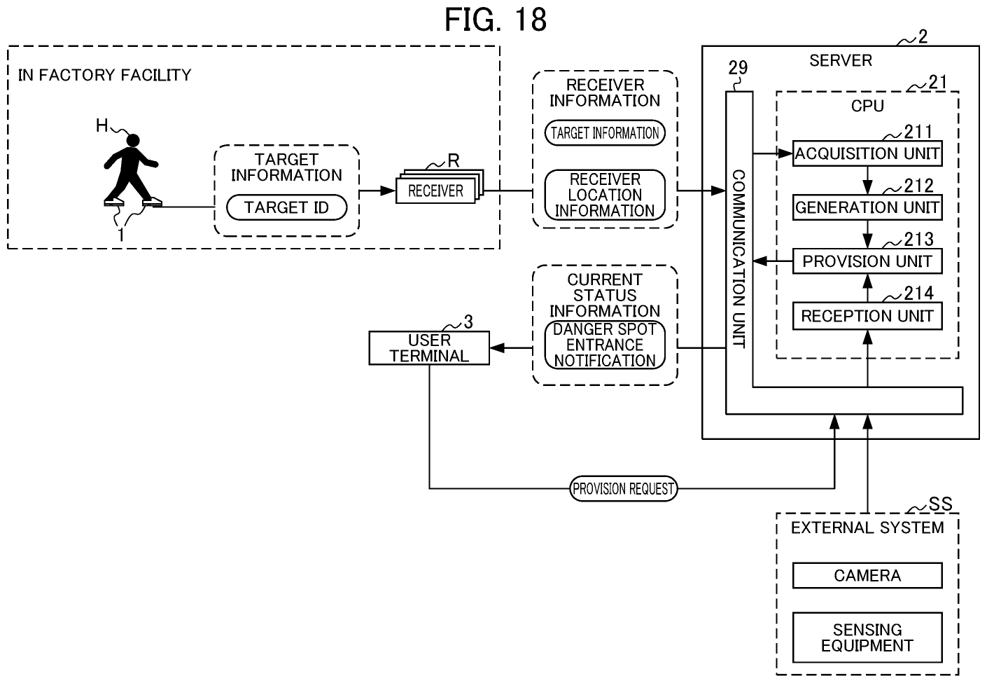

FIG. 18 is an image illustrating a case in which the information processing system including the server 2 having the functional configuration illustrated in FIG. 10 is applied to a factory management support service.

The subject service includes a service for supporting a person (the user U) who manages a factory facility by detecting activities of the target H who is engaged in work as a worker at the factory facility (hereinafter referred to as “factory management support service”). As illustrated in FIG. 18, according to the factory management support service, the target H who is a target to be managed in the factory facility wears a work shoe 100 on which the transmission device 1 is mounted to be engaged in work. Thus, for example, activities of the target H, such as walking in the factory, causes the transmission device 1 to transmit the target information.

If the target H is engaged in work at the factory facility, the target information transmitted from the transmission device 1 is received by a receiver R provided in the factory facility. The target information received by the receiver R is transmitted to the server 2 together with the receiver location information as the receiver information. Then, the server 2 acquires the transmitted receiver information, executes the above-described information providing process to generate the current status information, and transmits the current status information to the user terminal 3.

The server 2 herein acquires, in addition to the receiver information, information useful for supporting the person (the user U) who manages activities of the target H at the factory facility as the context information from the external system SS, and, on the basis of the acquired information, executes the above-described information providing process. The external system SS includes an image pick-up means capable of picking up an image of the target H who is engaged in work at the factory facility (e.g., a camera), sensing equipment capable of acquiring information indicating the state of the target H, and the like. Thus, the context information provided by the external system SS includes data of the picked-up image of the target H picked up by the image pick-up means of the external system SS and information indicating the state of the target H detected by the sensing equipment.

On the basis of the receiver information and the context information provided by the external system SS, the server 2 generates the current status information of the target H. In the example in FIG. 18, the generated current status information includes information necessary for improving the service at the factory. In addition, if the target H enters a danger spot at the factory, alert information or the like is generated as the current status information. The server 2 transmits the generated current status information in response to a provision request from the user terminal 3 as appropriate. In addition, the alert information is transmitted regardless of the presence or absence of a provision request from the user terminal 3. Thus, referring to the current status information including the information necessary for improving the service at the factory and the alert information, transmitted from the server 2 to the user terminal 3, the person (the user U) who manages activities of the target H at the factory facility can appropriately manage activities of the target H at the factory facility. In addition, the service at the factory facility can be improved.

Although the embodiment of the present invention has been described above, the present invention is not limited to the above-described embodiment, and any modification, improvement, or the like is also included in the present invention as long as the object of the present invention can be achieved .

For example, the target information transmitted from the transmission device 1 in the above embodiment does not include information indicating the location of the transmission device 1. That is, on the basis of information indicating the location of a receiver R that receives the target information transmitted from the transmission device 1, the current location of the transmission device 1 is specified. However, this is merely an example. The target information transmitted from the transmission device 1 may include information indicating the location of the transmission device 1.

In addition, for example, the transmission device 1 is mounted on the insole 500 in the above embodiment, but, without particular limitation thereto, may be attached to and disposed at any portion of a foot of the target H, for example.

Furthermore, for example, the method used for transmitting information from the transmission device 1 is a method for transmitting a beacon signal conforming to Blue Tooth (registered trademark), but, without particular limitation thereto, may be a method for using a set of LoRa LPWA (Low Power Wide Area)+GPS (Global Positioning System).

In addition, for example, the power source of the transmission device 1 in the above embodiment is a battery, such as a button battery or a magnesium battery, but, without particular limitation thereto, may be an external power source or automatic power generation.

Furthermore, the method for automatic power generation is not limited to a particular one and may be any method such as surface current, thermoelectric generation, or a power generating fiber. The power generated by the automatic power generation is preferably accumulated. The accumulation method is not limited to a particular one, and for example, a method using a magnesium battery or a supercapacitor can be employed.

In addition, for example, a piezoelectric element that generates power by the target H depressing the insole 500 is employed as the detection unit 12 of the transmission device 1, but, without particular limitation thereto, may also be, for example, any sensor can be used such as stepping, an acceleration sensor, a gyrosensor, or a temperature sensor.

For example, in the above-described embodiment, a dedicated application installed in the user terminal 3 and the target terminal 4 is started to use the subject service in the user terminal 3 and the target terminal 4. However, this is merely an example of a method for using the subject service. Without installing the dedicated application, each user may access a prescribed website and perform a prescribed login operation to be able to use the subject service.

In addition, the system configuration illustrated in FIG. 8 and the hardware configuration of the server 2 illustrated in FIG. 9 are merely examples for achieving the object of the present invention and are not limited to particular ones.

Furthermore, the functional block diagrams illustrated in FIGS. 7 and 10 are merely examples and are not limited to particular ones. That is, functions of entirely executing the above-described series of processes included in the information processing device or the information processing system may suffice, and the functional blocks for implementing the functions to be used are not particularly limited to the examples in FIGS. 7 and 10.

In addition, locations of the functional blocks are not limited to those in FIGS. 7 and 10 and may be any given locations. Furthermore, one of the functional blocks may be constituted by a hardware component alone, a software component alone, or a combination thereof.

In a case where the processing of each functional block is executed by software, a program configuring the software is installed in a computer or the like via a network or a recording medium. The computer may be a computer incorporated in dedicated hardware. Alternatively, the computer may be a computer that can execute various functions by installing various programs, such as a server or a general-purpose smartphone or personal computer.

The recording medium including such a program is constituted by a removable medium that is distributed separately from a device for providing the program for each user or is constituted by a recording medium or the like provided for each user in a state of being incorporated in the device in advance.

Note that the steps for describing the program to be recorded on the recording medium herein include, as well as processes performed in a time-series manner in its order, processes that are not necessarily performed in a time-series manner and executed concurrently or independently.

In addition, the term “system” herein means an entire device constituted by a plurality of devices, a plurality of means, and the like.

From the above, the following configurations may suffice the information processing device to which the present invention is applied, and various embodiments are possible. That is, the information processing device (e.g., the transmission device 1 in FIG. 1) to which the present invention is applied includes:

detection means (e.g., the detection unit 12 in FIG. 7) that detects a physical amount based on pressure from at least a portion (e.g., a sole) of a person's foot; and
transmission means (e.g., the transmission unit 112 in FIG. 7) that transmits prescribed information when the physical amount detected by the detection means satisfies a prescribed standard (e.g., exceeds a prescribed threshold).

Thus, it is possible to easily acquire information indicating the current status of a person who has difficulty in conveying information indicating their current status to others.

The transmission means may transmit, as the prescribed information, information that is used to specify a position at which the information processing device is present.

Thus, it is possible to easily acquire information indicating the current status of a person who has difficulty in conveying information indicating their current status including their current location to others.

The information processing device may be mounted on an item (e.g., the insole 500) that is to be in contact with or in a vicinity of the person's foot, and

the detection means may detect a depressing force or a physical amount based on the depressing force.

Thus, the target H can convey information indicating the current status including their current location to others by only wearing the insole 500.

In addition, in order to achieve the above object, an information processing system according to an aspect of the present invention includes:

a first information processing device (e.g., the transmission device 1 in FIG. 8) to be mounted on an item that is to be in contact with or in a vicinity of a person (e.g., the target H)'s foot; and a second information processing device (e.g., the server 2 in FIG. 8) that executes a prescribed process related to the person,
in which the first information processing device includes detection means (e.g., the detection unit 12 in FIG. 7) that detects a physical amount based on pressure from at least a portion of the person's foot, and
transmission means (e.g., a transmission unit 112 in FIG. 7) that transmits first information when the physical amount detected by the detection means satisfies a prescribed standard (e.g., exceeds a prescribed threshold), and
in which the second information processing device includes acquisition means (e.g., the acquisition unit 211 in FIG. 10) that acquires the first information, and
execution means (e.g., the generation unit 212 and the provision unit 213 in FIG. 10) that executes the prescribed process on the basis of the first information.

Thus, the target H can easily acquire information indicating the current status of the target H who has difficulty in conveying information indicating their current status to others.

The acquisition means may further acquire second information (e.g., context information) indicating a context regarding the person in addition to the first information, and the execution means may further execute the prescribed process on the basis of the second information in addition to the first information.

Thus, the target H can easily acquire information indicating the current status of the target H who has difficulty in conveying information indicating their current status including the context information to others.

The execution means may execute the prescribed process by using a location of the person specified on the basis of the first information.

Thus, the target H can easily acquire information indicating the current status of the target H who has difficulty in conveying information indicating their current status including the current location to others.

Furthermore, in the information processing system, the second information processing device may transmit certain information, such as results of the prescribed process, as FB information to the first information processing device. For example, as for the subject service in FIG. 1, the server 2 may transmit information to be provided for the user U (information indicating the current location of the target H, a wandering route, or the like) to the transmission device 1. In this case, the transmission device 1 preferably has a function of receiving the information and a function of notifying the user U of the information or information based on the information. For example, the transmission device 1 may notify the target H of the current location of the target H or may notify the target H of a certain alert if the current location of the target H is a location that needs an alert. The notification method for this case is not limited to a particular method, and any method may be employed, such as a notification method using an output mechanism (e.g., a speaker or a display) included in the transmission device 1 or a notification method using a device (e.g., wearable equipment that is owned by the target H and is not illustrated) independent of the transmission device 1.

### EXPLANATION OF REFERENCE NUMERALS

1: transmission device, 2: server, 3: user terminal, 4: target terminal, 11: management unit, 12: detection unit, 13: power supplying unit, 21: CPU, 22: ROM, 23:RAM, 24: bus, 25: input/output interface, 26: output unit, 27: input unit, 28: storage unit, 29: communication unit, 30: drive, 41: removable medium, 101: electronic component, 102: connector, 103: reinforcing material, 110: power source IC, 111: generation unit, 112: transmission unit, 211: acquisition unit, 212: generation unit, 213: provision unit, 214: reception unit, 500: item on which transmission device is mounted, B: nursing home, G: gate, U: user, H: target, R: receiver, F: flexible substrate, X: thickness, N: network, S: each step in subject service, SS: external server

1. An information processing device comprising:
a detection unit that detects a physical amount based on pressure from at least a portion of a person's foot; and
a transmission unit that transmits prescribed information when the physical amount detected by the detection unit satisfies a prescribed standard.

2. The information processing device according to claim 1,
wherein the transmission unit transmits, as the prescribed information, information that is used to specify a position at which the information processing device is present.

3. The information processing device according to claim 1,
wherein the information processing device is mounted on an item that is to be in contact with or in a vicinity of the person's foot, and
wherein the detection unit detects a depressing force or a physical amount based on the depressing force.

4. An information processing system comprising:
a first information processing device to be mounted on an item that is to be in contact with or in a vicinity of a person's foot; and
a second information processing device that executes a prescribed process related to the person,
wherein the first information processing device includes
a detection unit that detects a physical amount based on pressure from at least a portion of the person's foot, and
a transmission unit that transmits first information when the physical amount detected by the detection unit satisfies a prescribed standard, and
wherein the second information processing device includes
an acquisition unit that acquires the first information, and
an execution unit that executes the prescribed process on the basis of the first information.

5. The information processing system according to claim 4,
wherein the acquisition unit further acquires second information indicating a context regarding the person in addition to the first information, and
wherein the execution unit further executes the prescribed process on the basis of the second information in addition to the first information.

6. The information processing system according to claim 4 or 5,
wherein the execution unit executes the prescribed process by using a location of the person specified on the basis of the first information.
